(19) United States
(12) Patent Application Publication
(10) Pub. No.: US 2004/0128251 A1
(43) Pub. Date: Jul. 1, 2004

(54) Apparatus, system and method for licensing

(76) Inventors: Chris Adam, Norderstedt (DE); Markus Fritze, Norderstedt (DE)

Correspondence Address: James C. Scheller, Jr., BLAKELY, SOKOLOFF, TAYLOR & ZAFMAN LLP, Seventh Floor, 12400 Wilshire Boulevard, Los Angeles, CA, 90025-1026, US

(21) Appl. No.: 10/335,045

(22) Filed: Dec. 31, 2002

(51) Int. Cl. G06F 17/60

(52) U.S. Cl. 705/59

(57) ABSTRACT

A licensing apparatus may take the form of a key-sized article and be plugged into a USB port of a portable or other personal computer. The licensing apparatus has a unique identification code and comprises a processor and an interface for the computer. An end user applies to a software developer for an access code and provides the developer with the identification code of his licensing apparatus. The developer the generates an encrypted access code using the identification code and sends it to the end user. The user inputs the encrypted access code into the computer. The processor in the licensing apparatus is adapted to receive the encrypted access code via the interface; to decrypt the encrypted access code using the identification code; and to enable use by the computer of software associated with the encrypted access code.

### FIELD OF THE INVENTION

The present invention relates to effecting license agreements. In particular, the present invention relates to the distribution of software and to an apparatus, system and method of enforcing license agreements for software.

### BACKGROUND OF THE INVENTION

FIG. 1 illustrates a basic software structure. In the example of FIG. 1, the software comprises two layers. These layers are the operating system 110 and the application program 120. Operating system 110 is responsible for controlling the allocation and usage of hardware resources such as memory, central processing unit (CPU) time, disk space, and peripheral devices. Operating system 110 provides a variety of specific functions that can be utilized by a variety of software programs such as application program 120. Application program 120 provides specific end user functions, such as word processing, database management, and others. Application program 120 communicates with the computer hardware via functions provided by operating system 110. Operating system 110 provides an interface between hardware 100 and application program 120.

Generally, computer software such as application program 120 and operating system 100 is licensed to an end user for a fee. Thus, when a single user purchases a computer software package, he has at least an implied license authorizing him to use that software. The license fee is included in the purchase price. Similarly, an organization may purchase a software package with a license authorizing a predetermined number of persons in the organization to use the software. The license fee is calculated on the basis of the number of authorized users.

However, there is nothing to prevent the single user from allowing other unauthorized persons to use and make copies of the software as well. For example, if the software is provided on a CD-ROM, he may load the software onto the hard drive of his computer and pass the CD-ROM to unauthorized persons for their use. The unauthorized persons may also load the software onto the hard drives of their computers, thereby making unauthorized copies of the software. Of course, unauthorized copies may be disseminated by other means, such as the Internet.

In addition, even when an organization purchases a license for a predetermined number of authorized users, more than the authorized number of persons in the organization may nonetheless use the software, thereby breaking the terms of the license agreement.

Such abuse is hard to detect. Moreover, even when detected, it is difficult and costly to enforce a licensor's rights. Thus, the software industry experiences a considerable loss of revenue as a result of these and other forms of abuse. Accordingly, there is a need to provide an effective method of enforcing software licenses that is simple, cheap and prevents abuse of the licensor's rights.

FIG. 2 illustrates a second software structure. The software structure of FIG. 2 contains an additional layer of software, resource library 215, interposed between application program 220 and operating system 110. Resource library 215 provides a pre-packaged set of resources or routines that can be accessed by software programs such as application program 220 during execution. These resources provide higher level functions than those provided by operating system 210. For example, these resources may provide routines for managing a graphical user interface, for communicating with other companies via a network, or for passing messages between program objects. Typically, resource library 215 provides one or more resources or functions that can be used by many different software programs.

In addition to application programs, resource libraries are used by other types of software programs, including device drivers, utility programs and other resource libraries.

A software program typically utilizes a resource provided by a resource library by sending an appropriate message to the resource library and supplying the parameters required for the resource to be executed. Assuming the appropriate parameters have been supplied, the resource executes, and an appropriate response message is returned to the requesting program.

A software program may use resources provided by several different resource libraries, a resource library may be used by several different programs, and a resource library may itself use other resource libraries. FIG. 3 illustrates a computer system that includes several programs and several resource libraries. In the example of FIG. 3, there are two application programs 300 and 310, and three resource libraries 320, 330, 340. Application program 300 uses resources provided by operating system 110 and by resource libraries 320 and 330. Application program 310 uses resources provided by operating system 110 and by resource libraries 330 and 340. The resources of resource library 330 are thus shared by application programs 300 and 310.

Resource libraries are often packaged or “bundled” with an end user program by the maker of the program such that the end user receives a copy of resource libraries required by a program when the end user buys a copy of the program. The price of the resource library is built into the end user program price. The end user program developer, in turn, pays a royalty to the resource library vendor for the right to bundle and resell the resource library.

Since a resource library can be used with multiple end user programs, once the end user receives a copy of the resource library, the end user can use the resource library with any other program that is compatible with the resource library. In this case, the resource library vendor receives no additional revenue when the vendor's resource library is used with additional programs. Accordingly, it would be desirable for a resource library vendor to be able to ensure that an end user can use the resource library only with programs for which a license fee has been paid to the vendor for use of the resource library. Thus, there is also a need for a software mechanism for enforcing software license agreements that automatically ensures that a resource library can only be used by programs that have been licensed for use with the resource library by the resource library vendor.

One known method of solving this problem for resource libraries is disclosed in WO 99/05600A (Apple Computer, Inc.). This method is to embed a license text string and a corresponding license key in a program that has been licensed to use a resource library. The license text string and the license key are supplied, for example, by a resource library vendor to a program developer who wants to use the resource library with an end user program being developed.

The license text string includes information about the terms of the license under which the end user program is allowed to use the resource library. The license key is an algorithmic derivation, such as a digital signature, of the license text string that is used to authenticate the license text string. The resource library in turn is provided with a checking routine that includes means for reading the license text string and the license key, and for determining, using the license key, whether the license text string is authentic and whether the license text string has been altered. Resource library functions are made available only to a program having an authentic and unaltered license text string.

However, this method suffers a number of disadvantages. In particular, both the license text string and the license key are public and are independent of the copy of the software to be used and the computer on which the software is to run. Thus, once an end user has obtained a working license text sting and license key, he can input them in any copy of the application program. Accordingly, unauthorized copies of the license text string and the license key can be disseminated together with unauthorized copies of the application program. Thus, the loss of revenue experienced by the software industry is not satisfactorily stemmed by this solution.

In addition, since both the license text string and the license key are publicly known, unless the number of bits in the private key used by the vendor to derive the license key from the license text string is large, a determined hacker will be able to forge the private key. Once the hacker has forged the private key, he will be able to create his own license text strings and license keys and, hence, to circumnavigate the license enforcement method. To combat this, a 127-bit or greater private key may be used. However, this places an additional burden on the microprocessor used to operate the application program and the resource library.

A further problem is that it only prevents use of a resource library by an application program. However, it is not suitable for preventing use of application programs that do not use resource libraries.

### SUMMARY OF THE INVENTION

According to the present invention, there is provided a licensing apparatus having an identification code and comprising a processor and an interface for a computer, wherein the processor is adapted to receive via the interface an encrypted access code; to decrypt the encrypted access code using the identification code; and to enable use of software associated with the encrypted access code.

The licensing apparatus may take the form of a key-sized article, termed hereafter an access key, adapted to be plugged into a USB port of a portable or other personal computer. The identification code is specific to the access key. Software loaded on the computer requires authorization from the access key before use. For the access key to enable use, the end user applies to the developer for an access code and provides the developer with the identification code of his access key. The developer then generates an encrypted access code using the identification code of the end user's access key. The access key then attempts to use its identification code to decrypt the access code identification and, if decryption is successful, the access key enables use of the software.

According to another aspect of the present invention, there is provide a licensing system comprising: a computer for operating software; a licensing apparatus having an identification code and comprising a microprocessor; an interface provide between the computer and the licensing apparatus; and an encrypted access code associated with the software, wherein the licensing apparatus is adapted to decrypt the encrypted access code using the identification code and to enable use of the software by the computer.

According to yet another aspect of the invention, there is provided a method of licensing software comprising: providing a licensee with a licensing apparatus, the licensing apparatus having an identification code and comprising a microprocessor and an interface for a computer for operating the software; and providing the license with an encrypted access code associated with the software, wherein the licensing apparatus is adapted to decrypt the encrypted access code using identification code and to enable use of the software by the computer.

### BRIEF DESCRIPTION OF THE DRAWINGS

Embodiments of the present invention will now be described by way of further example only and with reference to the accompanying drawings, in which:

FIG. 1 illustrates an example of a software structure;

FIG. 2 illustrates an example of a software structure including a resource library;

FIG. 3 illustrates an example of a software structure including several application programs and resource libraries;

FIG. 4 is a schematic representation of a licensing apparatus according to the present invention;

FIG. 5 is a schematic representation of a system according to the present invention;

FIG. 6 illustrates an example of a licensing apparatus according to the present invention and a computer;

FIG. 7A is a flowchart showing one method of effecting a license according to the present invention;

FIG. 7B is an illustration of the apparatus used in the method shown in FIG. 7A;

FIG. 8A is a flowchart showing another method of effecting a license according to the present invention;

FIG. 8B is an illustration of the apparatus used in the method shown in FIG. 8A;

FIG. 9 is another schematic representation of a licensing apparatus according to the present invention; and

FIG. 10 is a flowchart showing another method of effecting a license according to the present invention.

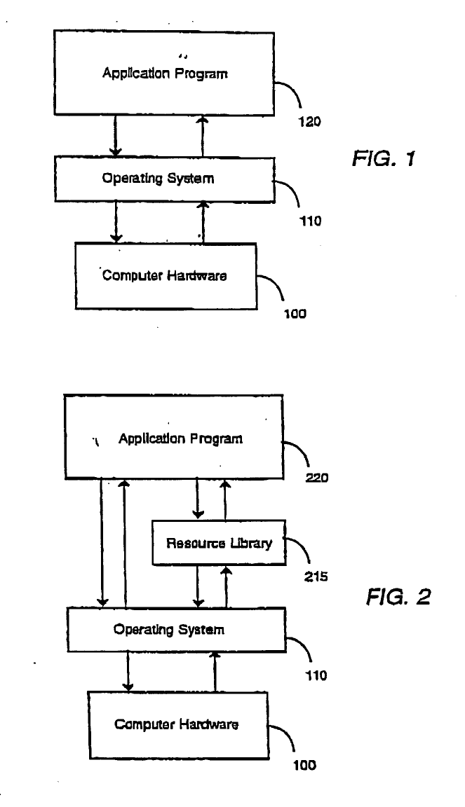

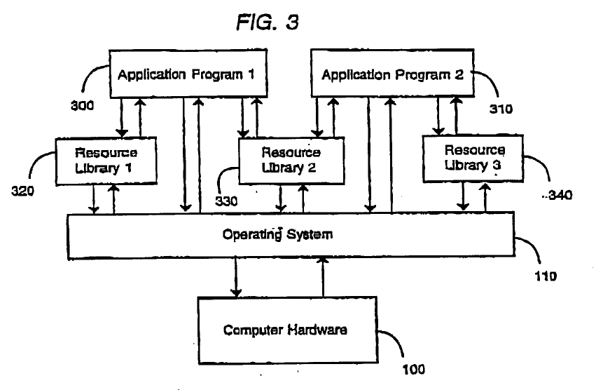

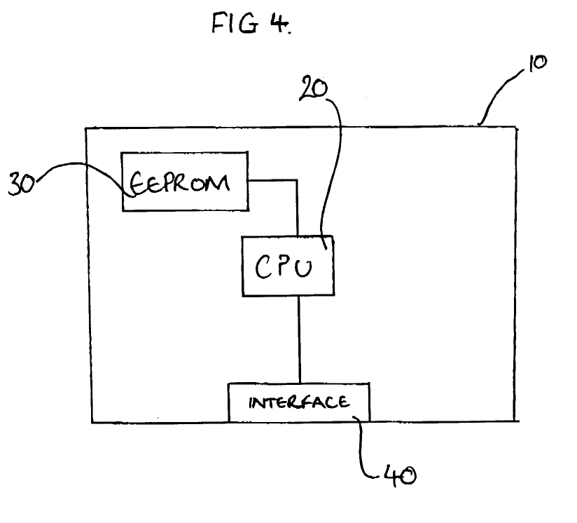

### DETAILED DESCRIPTION

An apparatus for effecting a license, a licensing system and a method of licensing software are described. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

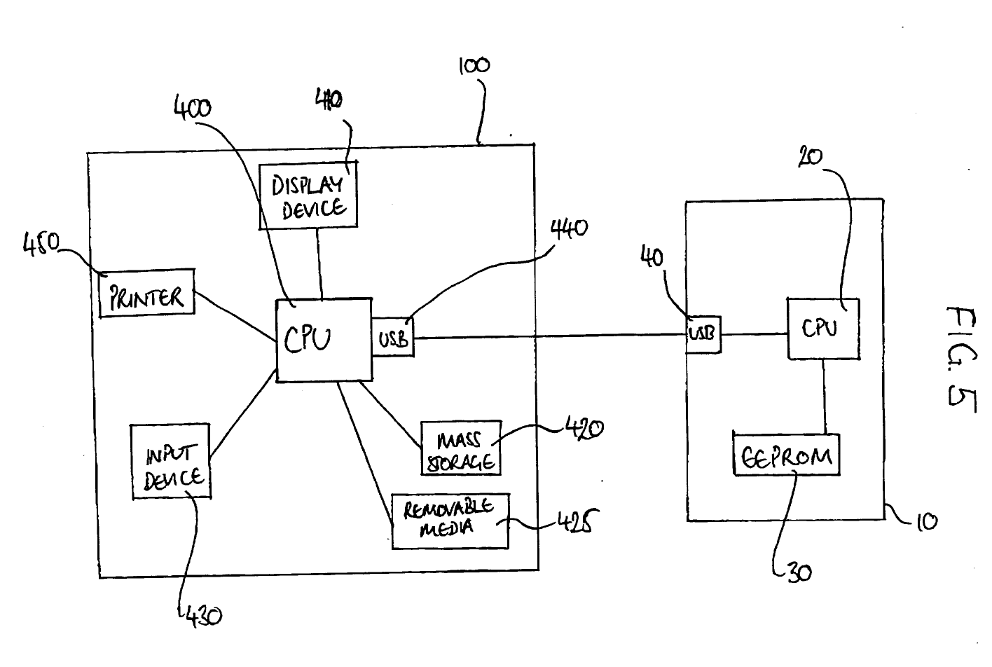

The licensing apparatus 10 of the present invention may be implemented in one embodiment as an approximately key-sized, portable article, as schematically illustrated in FIG. 4. Such a key-sized, portable article may be called an access key 10. This access key 10 includes a microprocessor 20 or other processing unit, an electronically erasable programmable read only memory (EEPROM) 30 and an interface 40. An identification code 150 or other identifier is stored in the EEPROM 30 and is preferably unique to the access key 10. The identification code 50 may comprise a series of bits, each set as a ‘1’ or a ‘0’ and may be encrypted before storage in the EEPROM 30. The interface 40 provides a connection between the processor 20 in the access key 10 and a computer 100 on which software is to be run. Preferably, the interface 40 is a universal systems bus (USB) plug suitable to be plugged into a USB port of the computer 100.

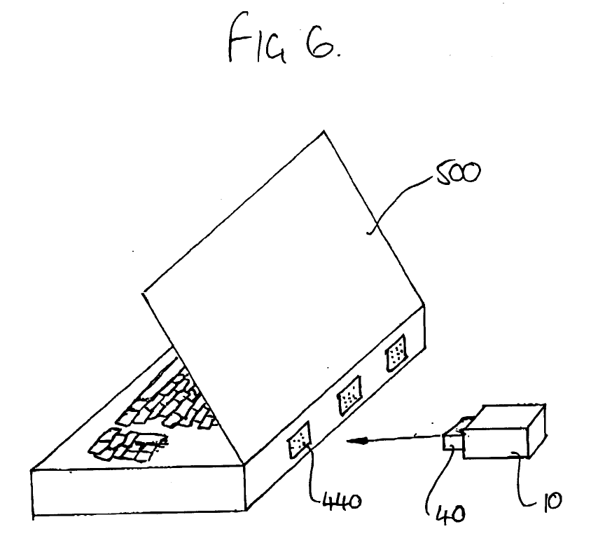

The present invention can be implemented using any of a variety of computer systems, including, without limitation, network computers, special purpose computers, and general purpose computers such as the general purpose computer 100 illustrated in FIG. 5. The computer shown in FIG. 5 includes a CPU unit 400 that includes a central processor, main memory, peripheral interfaces including USB port 440, input-output devices, power supply, and associated circuitry and devices; a display device 410 which may be a cathode ray tube display, LCD display, gas-plasma display, or any other computer display; an input device 430, which may include a keyboard, mouse, digitizer, or other input device; non-volatile storage 420, which may include magnetic, re-writable optical, or other mass storage devices; a transportable media drive 425, which may include magnetic, re-writable optical, or other removable, transportable media, and a printer 450. The CPU unit 400 may also include a network interface and/or a modem, allowing the computer system to communicate with other systems over a communications network such as the Internet or an Intranet. Any of a variety of other configurations of computer systems may also be used. In one embodiment, the computer system comprises an Intel Pentium (™) CPU and runs the Microsoft Windows 95 (™) operating environment. In another embodiment, the computer system comprises a Motorola 680X0 series CPU and runs the NeXTStep operating system.

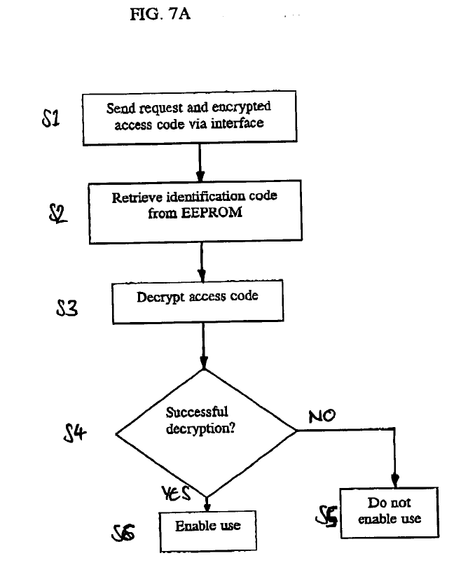

FIG. 6 shows an example of how the USB plug interface 40 of the access key 10 can be inserted into a USB port 440 of a laptop computer 500, in which the display screen and the keyboard are integrally provided.

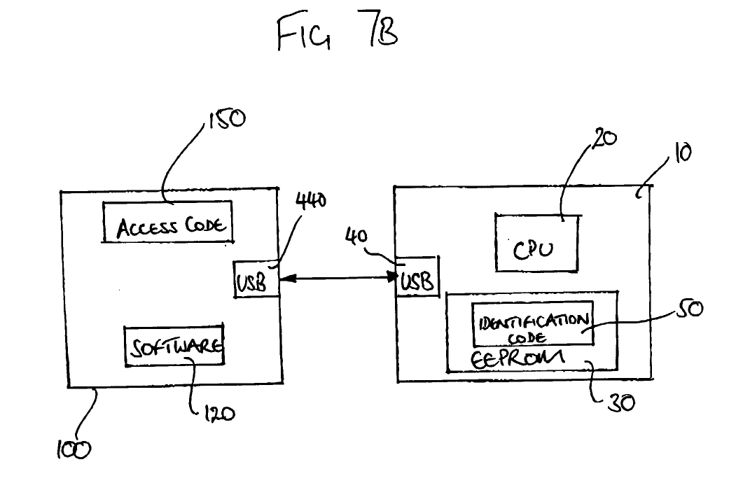

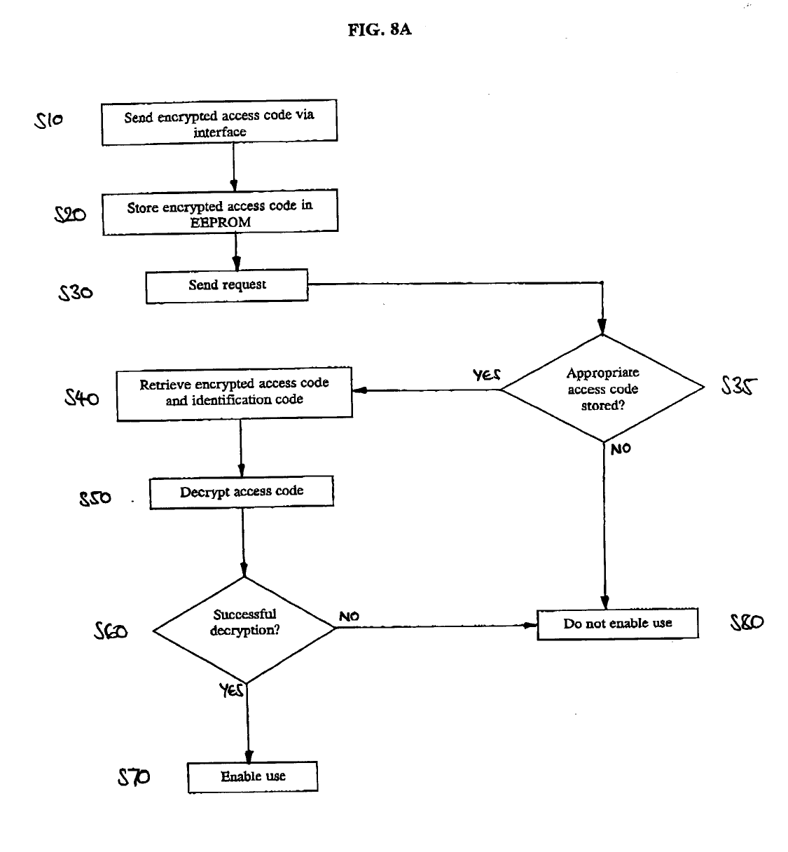

FIG. 7 is a flowchart showing one method of effecting a license according to the present invention. A user purchases a proprietary software program, such as an application program 120, from a developer and, at the same time, is provided with the access key 10. The developer also provides the user with an encrypted code fragment or access code 150, encryption of the access code 150 having been performed by the developer using the identification code 50 of the access key 10, which is preferably unique to the access key 10. The user then installs the application program 120 on his computer 100.

When the end user wishes to use the application program 120, he plugs the access key 10 into the USB port 440 of his computer 100 and, in response to a prompt from the application program 120, enters the encrypted access code 150 provided to him by the developer. The application program 120 then causes the computer 100 to send via the interface 440, 40 a request message to the microprocessor 20 of the access key 10, requesting the access key 10 to enable use of the application program 120. The encrypted access code 150 is sent together with the request (see S1 of FIG. 7).

Subsequently, the microprocessor 20 retrieves its identification code 50 from the EEPROM 30 (S2) and uses the identification code 50 to attempt to decrypt the encrypted access code 150 (S3). If the decryption is determined to be successful (S4), the microprocessor 20 returns a message to the computer 100 via the interface 40, 440 that use of the application program 120 is authorized (S6). However, if the decryption is determined to be unsuccessful (S4), the microprocessor 20 returns a message to the computer 100 that use of the application program 120 is not authorized (S6). Accordingly, a user must have a valid licensing apparatus 10 for successful operation of the proprietary application program 120. Thus, even if unauthorized copies of the application program 120 are made and distributed, unauthorized users will be unable to operate it.

In this embodiment of the present invention, as shown in FIG. 7B, the identification code 50 is stored in the EEPROM 30 of the access key 10, but the encrypted access code 150 is not. Thus, each time the user wishes to use the application program 120, he must plug the access key 10 into the USB port 440 of the computer 100 and enter the encrypted access code 150, for example using a keyboard as the input device 430, for decryption and subsequent authorization by the access key 10.

In its simplest embodiment, successful decryption of the encrypted access code 150 may require only that a predetermined bit of the identification code 50 of the licensing apparatus 10 is set as a ‘1’ (or a ‘0’, as the case may be). However, those skilled in the art will realize that significantly more complex encryption and decryption routines may be used, including numerous methods of “private key” encryption well known in the art. Adaptations of techniques used in “public key” encryption systems, such as the Diffie-Hellman scheme, the Massey-Omura cryptosystem, the ElGamal cryptosystem and elliptic curve cryptosystems could also be contemplated. In one simple system, the developer uses an assembler to convert unencrypted, or “plaintext”, instructions for the processor 20 in a particular licensing apparatus 10 using the identification code 50 of that licensing apparatus. This is the encrypted access code 150. Because only a fragment of encrypted code can ever be seen by the end 0user, the system is safe from “plaintext” attacks by hackers. Similarly, hackers will be unaware of the encryption system used and will not have access to either the identification code 50 of the licensing apparatus 10 or details of the assembler used for encrypting the access codes 150 by the developer. However, the precise encryption system used does not form a part of the present invention.

In a licensing system according to the present invention using the licensing apparatus 10, a proprietary software package may be sold to a user. Included in the package is a licensing apparatus 10 with a known unique identification code 50. In one embodiment, the encrypted access code 150 is also included in the package. The encrypted access code 150 is assembled by the developer using the known identification code 50 of the licensing apparatus. Thus, the access code 150 can be decrypted using the identification code 50.

The system allows numerous improvements in software licensing and protection. For example, software programs could be issued and disseminated freely, with charges only being made for issue of access codes 150 for specific licensing apparatuses 10. Different forms of access code 150 could be used for different programs. For example, a first program could require the third bit of the access code 150 to be a ‘1’ for the access code 150 to be decrypted, whereas a second program could require the ninth bit of the access code 150 to be a ‘0’ for the access code 150 to be decrypted. Accordingly, a user need only possess one licensing apparatus 10 and enter different access codes 150, each of which can be decrypted by the licensing apparatus 10, for various different programs. However, a user would require a valid licensing apparatus 10 for successful operation of the proprietary software. Thus, even if unauthorized copies of the software are made and distributed, unauthorized users will be unable to operate it.

The fact that the access code 150 is encrypted by the developer and is unique for a specific licensing apparatus 10 has many advantages. As discussed above, since the decrypted code or plaintext is never made available, “plaintext” attacks are defeated. In addition, a high degree of security may be provided with a comparatively simple encryption method—thus, 64-bit encryption or less is suitable. This reduces the size of the processor 20 required in the licensing apparatus 10. Moreover, if hackers are successful in defeating the system, it is a simple matter for the licensor to update the assembler and to issue new access codes 150 based on the updated assembler.

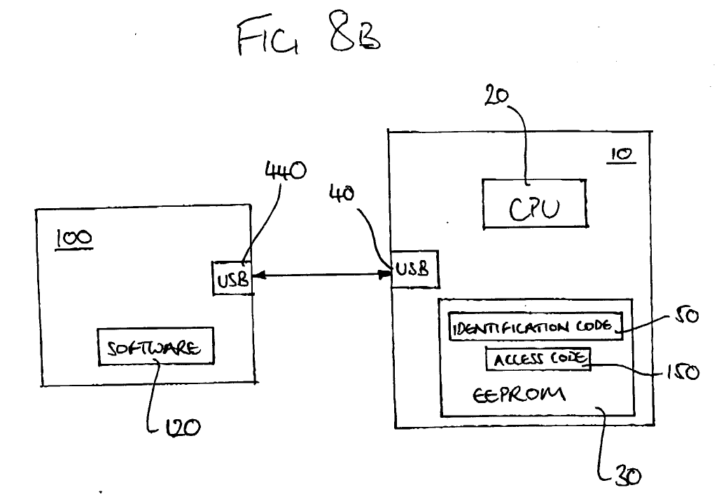

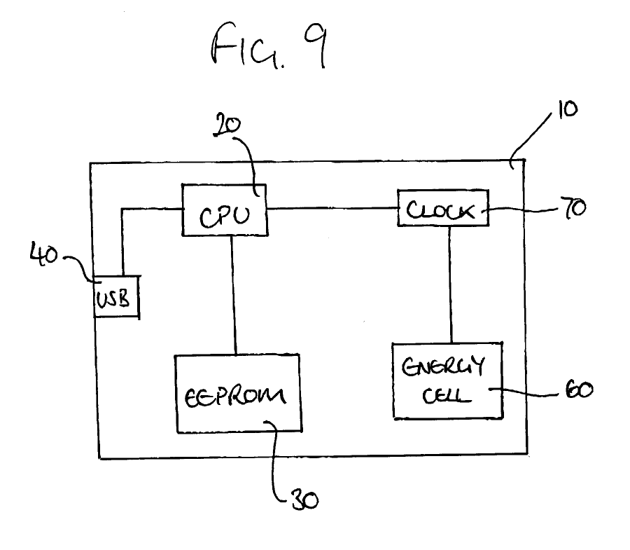

In another embodiment shown in FIGS. 8A and 8B, to prevent inconvenience to the user, once the encrypted access code 150 has been sent to the access key 10 for the first time (S10), it may be stored together with the identification code 50 in the EEPROM 30 (S20). When the user wishes to use the application program 120 subsequently, he needs simply to plug the access key 10 into the USB port 440 of the computer 100. When requesting authorization from the access key (S30), the software will query the processor 20 whether an appropriate encrypted access code 150 is stored in the EEPROM 30 (S35). For example, if encrypted access codes 150 are decimal and are 16 digits long, the software may query whether the access key 10 has an encrypted access code 150 comprising a ‘7’ as the ninth digit stored in the EEPROM 30. If no appropriate encrypted access code 150 is stored, then use of the application program 120 is not authorized (S80). However, if an appropriate encrypted access code 150 is stored, then the processor retrieves that encrypted access code 150 and its unique identification code 50 from the EEPROM 30 (S40) and conducts a decryption algorithm (S50). If decryption is successful, then use of the application program 120 is authorized (S70).

In addition, various different encrypted access codes 150 may be stored in the EEPROM 30 of the licensing apparatus 10 by the user. In conjunction with the identification code 50, each encrypted access code 150 allows operation of specific software. In this way, a user may insert his access key 10 in the USB port 440 of any computer 100 and immediately use software for which he has been given authorization, without re-entering his access code 150. In other words, each licensing apparatus 10 may store a large number of licenses. Of course, it would be possible to provide a “master” access key 10 allowing immediate use of all authorized programs, for example by storing on the access key 10 encrypted access codes 150 for all the proprietary software of the developer.

Needless to say, each computer 100 could store the specific encrypted access codes 150, for example on its hard drive 420, instead of storing the access codes on the access key 10. Each computer 100 could also store a plurality of specific access codes 150 under various user names for use with a corresponding plurality of access keys 10. Of course, it would also be possible to provide a master access key 10 with a identification code 50 that will operate with all access codes 150 stored by any computer 100 for all programs. Similarly, it would be possible to provide an access key 10 that will operate with all access codes 150 for some programs; or an access key 10 that will operate with some access codes 150 for all programs; or an access key 10 that will operate with some access codes 150 for some programs; as well as an access key 10 that will only operate with one access code 150 for each program.

In a preferred embodiment, the processor 20 included in the licensing apparatus 10 is a widely available microprocessor. However, any suitable processing module may be used.

In a preferred embodiment, an EEPROM 30 is used. Of course, other forms of memory may be provided for storing the identification code 50 and the encrypted access codes 150, including PROM, EPROM, flash memory, ROM and RAM, depending on how the licensing apparatus 10 is implemented. In another embodiment, the identification code 50 may be hardwired in the licensing apparatus 10. Moreover, although it is preferred, the encrypted access codes 150 need not be stored by the licensing apparatus 10. Thus, in some embodiments, no memory need be included in the licensing apparatus 10.

In a preferred embodiment, the interface between the licensing apparatus 10 and the computer 100 is provided by means of a USB plug 40 and a USB port 440. However, the present invention is not limited to this form of interface and any other suitable interface could be used. Numerous other forms of interface are already known, including Fireware and Bluetooth interfaces, and it is to be expected that other suitable forms of interface will be developed in the future. Operation of the present invention using the Internet or an Intranet, and suitable interfaces therefore, are also foreseen and included within the scope of the present invention.

It is envisaged that the licensing apparatus 10 could be powered through the interface. Thus, all the power required for operation of the processor 20 and for erasing and programming the EEPROM could be supplied through the USB interface. Alternatively, an energy cell may be provided in the licensing apparatus 10 to power some or all the components therein. The energy cell may be a battery, and may be rechargeable through the interface. Numerous, suitable secondary batteries are well known in the art.

In a preferred embodiment, the licensing apparatus 10 is implemented as a key-sized article suitable to be placed on a key ring. The article is encased in plastic to prevent access to the internal components thereof, in particular the processor 20 and the EEPROM 30, without irreparable damage to those components. Such an arrangement will thwart the efforts of hackers. In addition, individual end users, such as individuals within an organization, may each be provided with their own licensing apparatus 10 in the form of the key-sized article. Where access codes 150 are stored in the EEPROM 30, an individual need only insert his access key 10 in the USB port 440 of the computer 100 on which he wishes to operate the software. He is then enabled to use any software for which his licensing apparatus stores an appropriate access code. Thus, he need not be at his own computer or remember or carry his access codes 150 with him. This is particularly suitable for use with portable computers and, additionally, allows the use of one license for both office and home working.

However, numerous other arrangements may also be envisaged, including implementing the licensing apparatus 10 as a part of a server that authorizes users of computers included in a server network. Thus, the use of a key-sized access key is not an essential feature of the present invention.

In a further embodiment of the present invention, access codes 150 may be designed to allow only specified features of software, such as an application program, to operate. Accordingly, licenses for different levels of functionality can be provided using the same software source code and the same access key 10. For example, one access code 150 could be supplied at a first price and allow the licensee to perform only basic operations and access limited areas of any database provided by the software package. Another access code 150 could be supplied at a higher price and allow the licensee to perform more advanced operations and to access additional areas of the database, using the same software source code. Thus, many different levels of functionality can be provided.

As discussed above, access codes 150 may be provided in a sealed envelope together with a copy of the software and an access key 10. As an alternative, a user could purchase a copy of a software program and an access key 10 separately. He would then communicate the unique identification code 50 of the access key 10, the name of the software program and his payment details to the licensor. The licensor would then generate an appropriate access code 150 and communicate it to the licensee. Such an interaction lends itself particularly well to Internet use.

Another embodiment of the present invention is shown in FIG. 9. In this embodiment, the access key 10 is further provided with a power source 60, such as a secondary cell or other battery, and a clock 50. The processor 20 is adapted to perform a date algorithm on information included in the encrypted access code. Such information may include the start date, the end date and/or the duration of a license effected by the access code. On decryption of this data, the microprocessor then authorizes operation of the software accordingly.

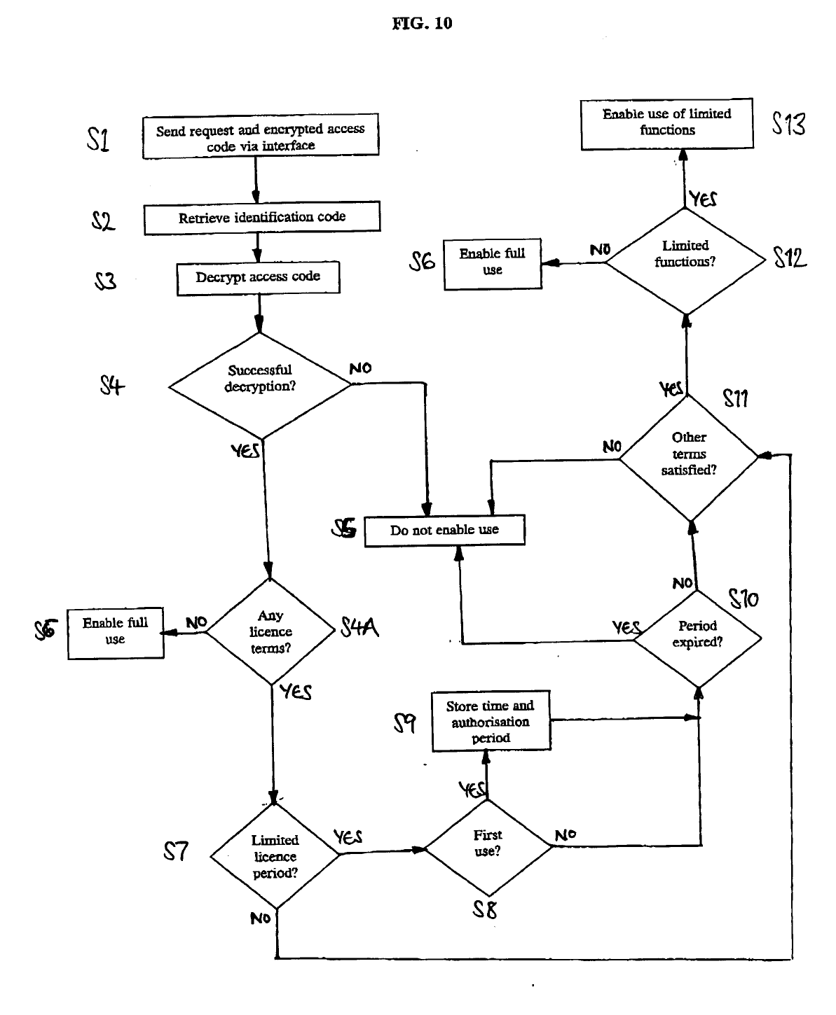

FIG. 10 shows one method of effecting a license using the access key shown in FIG. 9. In common with FIG. 7, the encrypted access code 150 is first sent together from the computer 100 to the access key with the request (S1). Subsequently, the processor 20 retrieves its identification code 50 from the EEPROM 30 (S2) and uses the identification code 50 to attempt to decrypt the encrypted access code 150 (S3). If the decryption is determined to be unsuccessful (S4), the processor 20 returns a message to the computer 100 that use of the software is not authorized (S6).

However, if decryption is determined to be successful (S4), the processor 20 then checks the decrypted access code 150 to determine whether the license includes any restrictions (S4A) before authorizing use. If there are no restrictions, then full use of the software is authorized (S6). On the other hand, if restrictions are included, the processor 20 then checks whether the restrictions include authorization for a limited period only (S7). If there are no such time-related restrictions, the processor moves to step S11. However, if there are time-related restrictions, the processor 20 establishes whether the access code 150 is being used for the first time (S8). If it is established that this is the first use of the access code, the processor saves the time of first use and the period for which the license is authorized (S9) in the EEPROM 30. If the access code 150 has been used before, the processor 20 retrieves the time of first use and the authorization period stored for that access code. The processor 20 then establishes the current time from the clock 50 and determines whether the license period has expired (S10). If the license period has expired, use of the software is not authorized (S5).

The processor then establishes whether any other terms must be satisfied for use to be authorized (S11). Once it has been determined the license is within the license period and all other license terms are satisfied, the processor establishes whether the access code 150 enables limited functionality (S12) and, depending on the determination, either authorized full use of the software (S6) or limited use (S13).

Of course, steps S1 to S4 of FIG. 10 may be substituted with steps S10 to S60 of FIG. 8A.

For example, it may be desired to provide a prospective user with a copy of an application program 120, but to allow him only limited use of the application program 120 for three months from the date of first use. Effectively, the user would be provided with a limited period demonstration version of the application program 120. In that case, the user may be provided with an encrypted access code 150 containing this information. When the processor 20 decrypts the access code 150 for the first time, stores either the access code 150 or an identifier for the access code, together with the time of first use of the access code 150 and the license period in associated portions of the EEPROM 30. The clock 50, powered by the energy cell 60, is then used to establish whether the license period has expired.

Of course, other methods could be used. For example, the licensing apparatus 10 may store a specified start date, rather than the date of first use, and the end date in the EEPROM 30. In addition, the end date may be determined as the function of the date of first use plus the duration of the license, as described above, or may be included as a predetermined final date in the encrypted access code. The processor 20 may then compare the clock 50 provided in the licensing apparatus 10 with the stored dates to determine whether the encrypted access code 150 is valid at the time of the request. Since the clock 50 is independent of the computer 100 and is powered by a separate power source 60, and both may be provided in a sealed casing, the license cannot be cheated by resetting the clock of the computer 100 or shutting off the power supply to the clock.

Naturally, it would also be possible to rely on a clock included in the computer 100 to provide time information to the processor 20 in the licensing apparatus 10.

The provision of a clock in the licensing apparatus 10 as set out above allows limited duration demonstration software to be released without detracting from eventual sales. Thus, developers may distribute copies of their proprietary software free of charge and need not be concerned if unauthorized copies are made. To operate the software, users obtain a licensing apparatus 10, which may also be provided free of charge. Encrypted access codes 150 allowing access only to demonstration features of the software may be provided free of charge with the licensing apparatus 10. Such access codes 150 may or may not limit the period of the license. Similarly, full access to the software may be provided free of charge, but for a limited period only.

In one example, if the software package is a music synthesis program, then the user may be provided free of charge with an access code 150 authorizing access for a period of three months to predetermined electronically-implemented instruments provided by the program. In this time, he may create and store numerous musical compositions using the authorized portions of the software. However, once the three month license period has expired, he will be unable to access his compositions for either playback or editing. To do so, he must apply to the developer for a further license and supply his license apparatus's identification code 50. The developer's fee for providing a new access code 150 will be dependent on the license period and the functionality requested. Thus, the fee for a further three month license for only the predetermined instruments would be smaller than the fee for a year long license for all the instruments available in the package.

The present invention also allows the easy implementation of software rental and periodic licensing, for example, of a computer game. Presently, users purchase computer game software stored on CD ROM or another suitable medium from retailers, the purchase including an implicit license to use the game indefinitely. This is expensive for the user and encourages unauthorized copies of the game to be made. Alternatively, users travel to video rental or other stores that also provide game rental services and rent a CD-ROM on which the game software is stored. The typical rental period is one or only a few days. This is inconvenient for the user.

Using the present invention, the software itself can instead be made freely available. Access codes 150 can then be supplied by licensors in the manner discussed above for short-term usage of the game. Thus, a user can download a copy of the software on to the hard drive of his computer 100 free of charge or purchase the appropriate CD-ROM at little cost. If he wishes to play the game for one day, he can e-mail the identification code 50 of his licensing apparatus 10 to the licensor together with his payment details and a request for a one-day license. The assembler used by the developer can then automatically assemble and encrypt an appropriate access code 150 and immediately e-mail it to the user.

In this way, users may effectively rent a game for a limited period. This saves the user the expense of purchasing the game at full cost and the inconvenience of traveling to a video rental or other store first to rent and then to subsequently return the game. In addition, encrypted access codes 150 of this sort can be purchased as gifts for others. They can also be used to effectively limit the amount of time children spend playing games in the home. For example, a parent can purchase an access code 150 that allows games to be played only at certain times of the day and/or on certain days of the week.

Of course, rental services of this kind are not limited to games but can extend to all other forms of software and software packages, to music rental, film rental and so forth.

The use of a clock 50 also allows licensors to offer an insurance scheme to licensees. In such a scheme, a licensee is provided with a new access code 150 at regular intervals—for example, every four weeks. Each access code 150 is valid only up to the time the next access code 150 is due to be supplied. Since the access key 10 itself is cheaply produced, there is no problem if the licensee loses his access key 10. Even if the licensee loses his access key 10 at the beginning of the current license period, the access key 10 can be cheaply replaced and the licensor can confidently supply a replacement access code 150 for the new key at little or no charge without fear that it could be used by unauthorized persons. In addition, if the licensee's key is stolen or found by an unauthorized person, the unauthorized person will obtain only limited use from the licensing apparatus 10 since the license period is short and will expire soon after. Moreover, to obtain new access codes 150, the unauthorized person must also obtain the identification code 50 of the licensing apparatus 10 and apply to the developer. Thus, if loss or theft has been reported to the licensor, the unauthorized person's whereabouts can be more easily tracked.

Of course, it would also be possible for different software houses and developers to use different licensing apparatuses 10 or they may use a single licensing apparatus 10.

In addition, it is also be possible for an encrypted access code 150 to include instructions to authorize use of a program only a predetermined number of times. As discussed above in respect of time-related licenses, this can be implemented simply by using the processor 20 and EEPROM 30 already provided in the licensing apparatus or access key 10. Alternatively, an additional counter circuit may be included. This is particularly suitable where the software to be licensed allows the user to play a game, to watch a film or to listen to music; or is a game, a film or a piece of music.

Moreover, the present application is not limited only to licensing of software and other source code. Nor is it limited to licensing per se. Also included within the scope of the claims appended herewith is a vending machine, for example for canned drinks, allowing use of an access key on which one or more appropriate access codes 150 have been previously stored. The vending machine sends a request to the access key 10 to enable use of software associated with an encrypted access code 150 stored on the access key 10, the software for vending a canned drink. A previously stored access code 150 may include instructions for the access key to authorize the vending machine to dispense a predetermined number of cans of one type of drink. The same or a different previously stored access code 150 may instruct the access key to authorize the vending machine to dispense a predetermined number of cans of a different type of drink. The access code 150 or codes may also include other sorts of restriction, including time-related restrictions. Of course, the present invention is not limited to vending machines for canned drinks but includes within its scope all dispensing machines, for such diverse items as newspapers and other media, gasoline, chocolate, sanitary goods and so forth. In effect, the license provided by the licensing apparatus 10 is a pre-purchase of the goods dispensed by the vending machine.

Other implementations of the present invention are also envisaged.

In summary, in a preferred embodiment each licensing apparatus 10 is a key-sized article and has a unique identification code 50; requires a specific access code 150 for each software license that is to be enabled; stores a plurality of such access codes 150; and comprises a clock for enabling time-dependent licenses. The article includes a processor, an EEPROM, a USB interface and a battery for powering the clock. The battery may be recharged through the USB port. Alternatively, if no clock is provided, the battery may be omitted and the processor may be powered directly through the USB port. However, numerous alternatives including those described above, all falling within the scope of the present invention, are possible. The present invention also includes a licensing system and method.

Thus, an improved method and apparatus for enforcing software licenses has been presented. Although the present invention has been described with respect to certain example embodiments, it will be apparent to those skilled in the art that the present invention is not limited to these specific embodiments. For example, although the invention has been described for use in stand-alone computer systems, the invention can be used to enforce licenses in a network environment as well. Further, although the operation of certain embodiments has been described in detail using application programs and certain detailed process steps, different software may be used, and some of the steps may be omitted or other similar steps may be substituted, without departing from the scope of the invention. Other embodiments incorporating the inventive features of the present invention will be apparent to those skilled in the art.

Thus, the foregoing description has been given by way of example only and it will be appreciated by a person skilled in the art that modifications can be made without departing from the scope of the present invention.

What is claimed is:

1. A licensing apparatus having an identification code, the licensing apparatus comprising:
a processor; and
an interface for a computer, wherein the processor is adapted to receive via the interface an encrypted access code; to decrypt the encrypted access code using the identification code; and to enable use of software associated with the encrypted access code.

2. A licensing apparatus according to claim 1, wherein the identification code is unique to the licensing apparatus.

3. A licensing apparatus according to claim 1, wherein the identification code is hardwired in the licensing apparatus.

4. A licensing apparatus according to claim 1, wherein the licensing apparatus further comprises a memory and the identification code stored is stored in the memory.

5. A licensing apparatus according to claim 4, wherein the memory is an EEPROM.

6. A licensing apparatus according to claim 1, wherein the interface comprises a USB interface, a Fireware interface, a Bluetooth interface, a radio interface, a modem or other firmware.

7. A licensing apparatus according to claim 1, wherein the access code is encrypted remotely using the identification code.

8. A licensing apparatus according to claim 1, wherein the encryption of the access code is 64-bit encryption or less.

9. A licensing apparatus according to claim 4, wherein the licensing apparatus further comprises a memory and the encrypted access code is stored in the memory.

10. A licensing apparatus according to claim 9, wherein the memory is an EEPROM.

11. A licensing apparatus according to claim 9, wherein the processor is adapted to receive a query from the computer whether an access code associated with software operated by the computer is stored by the licensing apparatus and, if so, to decrypt the stored access code and to enable use of that software.

12. A licensing apparatus according to claim 1, wherein the processor is adapted to receive an encrypted access code from the computer when use of software associated with that access code is required to be enabled.

13. A licensing apparatus according to claim 1, wherein the processor enables use only of specified features of the software associated with the encrypted access code, dependent on information included in the encrypted access code.

14. A licensing apparatus according to claim 1, wherein the processor enables use of the software associated with the encrypted access code only for a specified period, dependent on information included in the encrypted access code.

15. A licensing apparatus according to claim 14, wherein the end of specified period is defined as a fixed date.

16. A licensing apparatus according to claim 15, further comprising an internal clock and an energy cell for powering the clock, wherein the processor determines whether the period has expired using the internal clock.

17. A licensing apparatus according to claim 14, wherein the end of the specified period is defined as a time after first decryption by the licensing apparatus of the encrypted access code or another predetermined event.

18. A licensing apparatus according to claim 17, further comprising an internal clock and an energy cell for powering the clock, wherein the processor determines whether the period has expired using the internal clock.

19. A licensing apparatus according to claim 1, which is portable.

20. A licensing system, comprising:
a computer for operating software;
a licensing apparatus having an identification code and comprising a processor;
an interface provided between the computer and the licensing apparatus; and;
an encrypted access code associated with the software, wherein the licensing apparatus is adapted to decrypt the encrypted access code using the identification code and to enable use of the software by the computer.

21. A licensing system according to claim 20, wherein the identification code is unique to the licensing apparatus.

22. A licensing system according to claim 20, wherein the identification code is hardwired in the licensing apparatus.

23. A licensing system according to claim 20, wherein the licensing apparatus further comprises a memory and the identification code is stored in the memory.

24. A licensing system according to claim 23, wherein the memory is an EEPROM.

25. A licensing system according to claim 20, wherein the interface comprises a USB interface, a Fireware interface, a Bluetooth interface, a radio interface, a modem or other firmware.

26. A licensing system according to claim 20, wherein the access code is encrypted remotely using the identification code.

27. A licensing system according to claim 20, wherein the encryption of the access code is 64-bit encryption or less.

28. A licensing system according to claim 20, wherein the licensing apparatus further comprises a memory and wherein the encrypted access code is initially provided to the licensing apparatus either by said computer or by another computer and is stored by the licensing apparatus in the memory.

29. A licensing system according to claim 28, wherein the memory is an EEPROM.

30. A licensing system according to claim 28, wherein the licensing apparatus is adapted to receive a query from said computer whether an access code associated with software operated by the computer is stored by the licensing apparatus and, if so, to decrypt the stored access code and to enable use of that software.

31. A licensing system according to claim 20, wherein the licensing apparatus is adapted to receive an encrypted access code from the computer when use of software associated with that access code is required to be enabled.

32. A licensing system according to claim 20, wherein the licensing apparatus enables use only of specified features of the software associated with the encrypted access code, dependent on information included in the encrypted access code.

33. A licensing system according to claim 20, wherein the licensing apparatus enables use of the software associated with the encrypted access code only for a specified period, dependent on information included in the encrypted access code.

34. A licensing system according to claim 33, wherein the end of specified period is defined as a fixed date.

35. A licensing system according to claim 34, wherein the licensing apparatus further comprises an internal clock and an energy cell for powering the clock, wherein the processor determines whether the period has expired using the internal clock.

36. A licensing system according to claim 33, wherein the end of the specified period is defined as a time after first decryption by the licensing apparatus of the encrypted access code or another predetermined event.

37. A licensing system according to claim 36, wherein the licensing apparatus further comprises an internal clock and an energy cell for powering the clock, wherein the processor determines whether the period has expired using the internal clock.

38. A licensing system according to claim 20, wherein the licensing apparatus is portable.

39. A method of licensing software, comprising:
providing a licensee with a licensing apparatus, the licensing apparatus having an identification code and comprising a processor and an interface for a computer for operating the software; and
providing the licensee with an encrypted access code associated with the software, wherein the licensing apparatus is adapted to decrypt the encrypted access code using the identification code and to enable use of the software by the computer.

40. A method of licensing software according to claim 39, comprising using an identification code unique to the licensing apparatus.

41. A method of licensing software according to claim 39, comprising
hardwiring the identification code in the licensing apparatus.

42. A method of licensing software according to claim 39, wherein the licensing apparatus further comprises a memory and wherein the method further comprises storing the identification code in the memory.

43. A method of licensing software according to claim 42, comprising using an EEPROM for storing the encrypted access code.

44. A method of licensing software according to claim 39, comprising using a USB interface, a Fireware interface, a Bluetooth interface, a radio interface, a modem or other firmware for the interface.

45. A method of licensing software according to claim 39, comprising encrypting the access code remotely using the identification code.

46. A method of licensing software according to claim 39, comprising using 64-bit encryption or less for encryption of the access code.

47. A method of licensing software according to claim 39, wherein the licensing apparatus further comprises a memory and wherein the method further comprises inputting the encrypted access code to the licensing apparatus using either said computer or another computer and storing the encrypted access code in the memory.

48. A method of licensing software according to claim 47, comprising using an EEPROM as the memory.

49. A method of licensing software according to claim 47, comprising sending a query from said computer to the licensing apparatus whether an access code associated with said software is stored by the licensing apparatus and, if so, decrypting the stored access code to enable use of that software by the computer.

50. A method of licensing software according to claim 39, comprising sending an encrypted access code from the computer to the licensing apparatus when use of software associated with that access code is required to be enabled.

51. A method of licensing software according to claim 39, comprising including information in the encrypted access code so that the licensing apparatus enables use only of specified features of the software associated with the encrypted access code, dependent on information included in the encrypted access code.

52. A method of licensing software according to claim 39, comprising including information in the encrypted access code so that the licensing apparatus enables use of the software associated with the encrypted access code only for a specified period, dependent on information included in the encrypted access code.

53. A method of licensing software according to claim 52, comprising defining the end of specified period as a fixed date.

54. A method of licensing software according to claim 53, wherein the licensing apparatus further comprises an internal clock and an energy cell for powering the clock, wherein the processor determines whether the period has expired using the internal clock.

55. A method of licensing software according to claim 52, comprising defining the end of the specified period as a time after first decryption by the licensing apparatus of the encrypted access code or another predetermined event.

56. A method of licensing software according to claim 55, wherein the licensing apparatus further comprises an internal clock and an energy cell for powering the clock, wherein the processor determines whether the period has expired using the internal clock.

57. A method of licensing software according to claim 39, wherein the licensing apparatus is portable.

58. A rental method for software, comprising:
providing a user with an apparatus, the apparatus having an identification code and comprising a processor and an interface for a computer for operating the software; and
providing the user with an encrypted access code associated with the software, wherein the apparatus is adapted to decrypt the encrypted access code using the identification code and to enable use of the software by the computer.

59. A vending or dispensing method for goods, comprising:
providing a dispensing machine comprising a computer for running software for dispensing the goods;
providing a user with an apparatus, the apparatus having an identification code and comprising a processor and an interface for the computer of the dispensing machine; and
providing the user with an encrypted access code associated with the software, wherein the apparatus is adapted to decrypt the encrypted access code using the identification code and to enable use of the software by the computer.
